(19) United States
(12) Patent Application Publication
(10) Pub. No.: US 2012/0324742 A1
(43) Pub. Date: Dec. 27, 2012

(54) Power Tool Unit with Adjustable Working Element

(76) Inventor: Kai Bau-Madsen, Huntingdon Valley, PA (US)

(21) Appl. No.: 13/169,531

(22) Filed: Jun. 27, 2011

(51) Int. Cl. B23D 45/14; B23D 47/02; B23D 45/16

(52) U.S. Cl. 30/376; 83/13; 83/859

(57) ABSTRACT

A power tool and method of using the power tool is described. The power tool includes a support platform component including a handle and a base plate, and a power tool component includes a working element and means for engaging the support platform that allows for rotational or pivotal movement of the power tool relative to the support platform component.

The power tool also includes an adjustment mechanism that allows the working element of the power tool to be adjusted to an angle relative to the base plate that is different from the angle of the handle relative to the base plate.

### BACKGROUND OF THE INVENTION

Circular saws having an adjustable base plate are known in the art. For example, these plates can be pivotally connected at their forward end to the saw housing or frame for swinging movement about an axis parallel the axis of rotation of the blade mounting shaft. Further, the base plates may be adjustably mounted in any desired position between a so-called normal position and a position inclined with respect thereto. The base plate may also be mounted so as to provide for pivotal movement about its longitudinal axis to perform bevel and miter sawing.

However, circular saws today are designed in such a way that the handle is always required to have the same angular position as the cutting blade. For example, most circular saw handles form part of the saw housing, and are not adjustable with respect to the cutting blade and motor. Other saws are designed with the handle as an extension of the housing, or fixedly attached to the saw, but the functionality remains the same—the angular position of the handle with respect to the cutting blade is the same. In other words, while the angle of the base plate can adjust with respect to the remainder of the circular saw, the handle and cutting blade cannot ever adjust with respect to each other.

Thus, there remains a need in the art for a power tool, such as a circular saw, where the cutting blade or working element can be adjusted to an angle with respect to the base plate that is different from the angle of the handle with respect to the base plate. The present invention satisfies this need.

### SUMMARY OF THE INVENTION

A power tool is described. The power tool includes a support platform component including a handle and a base plate, and a power tool component including a working element and means for engaging the support platform component that allows for rotational or pivotal movement of the power tool component relative to the support platform component. The power tool also includes an adjustment mechanism that allows the working element of the power tool component to be adjusted to an angle relative to the base plate that is different from the angle of the handle relative to the base plate. In one embodiment, the angle of the handle with respect to the base plate is substantially perpendicular. In another embodiment, the angle of the working element relative to the base plate is between 1-90°. In another embodiment, the adjustment mechanism is releasably locked into position. In another embodiment, the locked position represented a predetermined angle of the working element relative to the base plate. In another embodiment, a plurality of predetermined angle settings are designated on the adjustment mechanism. In another embodiment, the support platform component is at least partially integrated into a housing of the power tool. In another embodiment, the power tool is a circular saw. In another embodiment, the working element is a cutting blade. In another embodiment, the cutting blade makes a beveling or mitering cut angle while the handle is substantially perpendicular to the base plate.

A method of cutting a substantially planar surface at an angle with a power tool is also described. The method includes the steps of placing a circular saw including a handle, cutting blade, motor and base plate on a surface to be cut, such that the base plate is substantially flush with the surface, the handle is substantially perpendicular with respect to the base plate and the cutting blade can proceed along a cutting line on the surface, adjusting the angle of a cutting blade, without substantially altering the position of the handle relative to the base plate, and activating the cutting blade to cut the surface at an angle along the cutting line.

Also described. is a support platform for a power tool. The support platform includes a handle, handle arm and a base plate, wherein the handle arm or base plate includes a means for engaging a power tool component that allows for rotational or pivotal movement of the power tool component relative to the handle and base plate. The support platform also includes an adjustment mechanism in the handle arm that allows a working element of the power tool component to be adjusted to an angle relative to the base plate that is different from the angle of the handle relative to the base plate.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a perspective view of an exemplary saw handle and base plate according to the present invention, with a circular saw engaged thereto.

FIG. 2 is a perspective view of the exemplary saw handle and base plate according to FIG. 1, with a circular saw engaged and positioned for cutting at an angle away from vertical.

FIG. 3 is a front view of the handle and circular saw of FIG. 2.

FIG. 4 is a perspective view of the exemplary saw handle and base plate, separate from a circular saw or other power tool.

FIG. 5 is a front view of the exemplary saw handle and base plate of FIG. 4.

FIG. 6 is a side view of the exemplary saw handle and base plate of FIG. 4.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in power tool components, and the methods of manufacturing and using the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. Therefore, the disclosure herein is directed to all such variations and modifications to such elements and methods as would be understood by those skilled in the art. Furthermore, the embodiments identified and illustrated herein are for exemplary purposes only, and are not meant to be exclusive or limited in their description of the present invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Further, all numerical designations are approximations which may be varied (+) or (−) by increments of 0.1. It is to be understood, although not always explicitly stated that all numerical designations are preceded by the term “about”.

The present invention provides a new and improved mechanism for enabling adjustment of the angle of a circular saw blade (or other power tool) with respect to the base plate between a default “vertical” position to an angled position, or a position inclined relative thereto. It should be appreciated that while the present invention is generally described and illustrated herein as being suitable for a circular saw, virtually any power tool can be inserted into the device of the present invention, such that a cutting or working element of the tool extends beyond or below the base plate component, through a designated opening in the base plate.

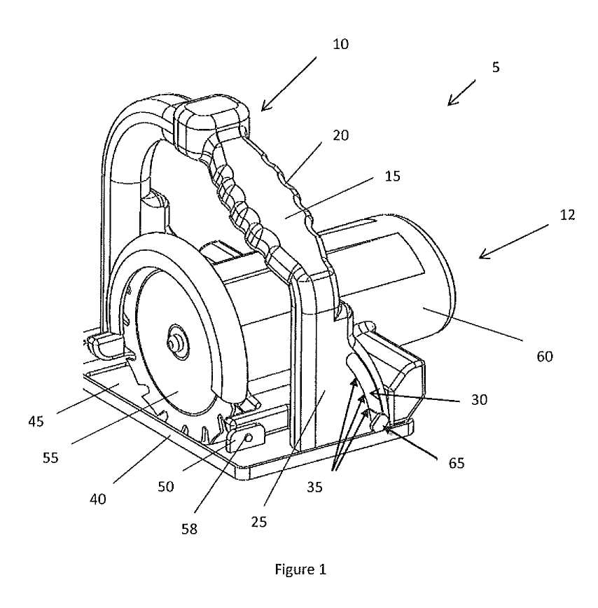

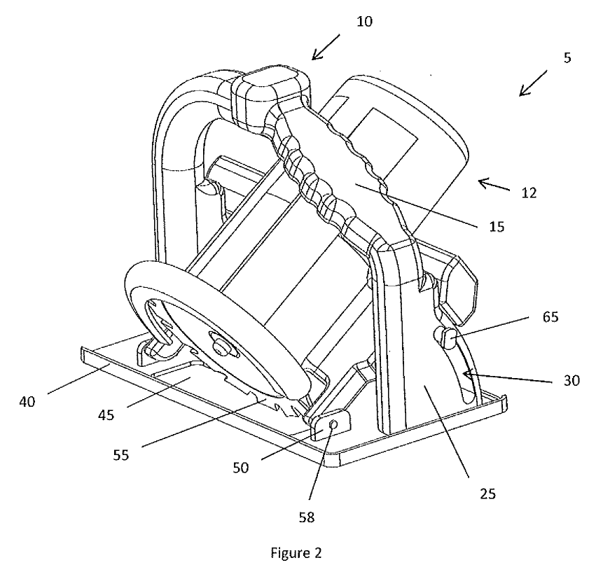

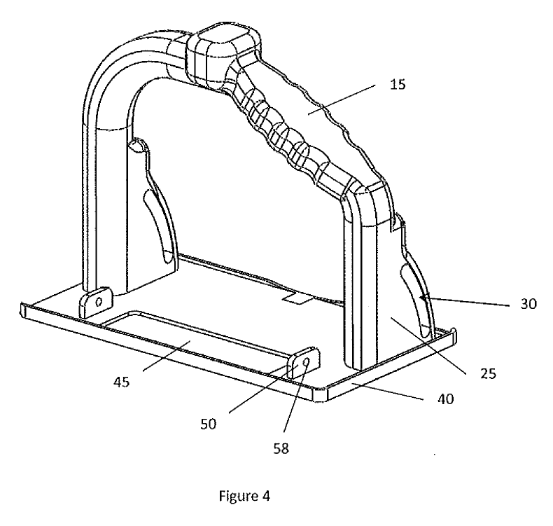

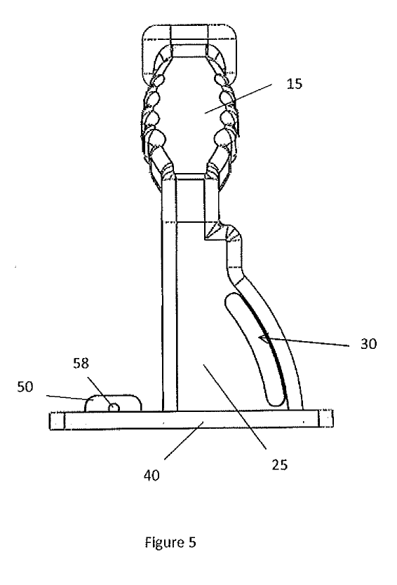

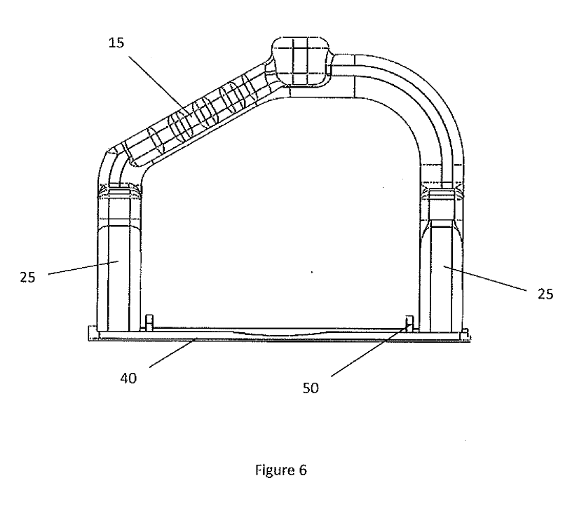

As contemplated herein, the present invention relates to a device having improved control and stability when the blade or working element of a power tool is cutting at an angle away from vertical, or away from approximately perpendicular to the working surface plane. The device may generally include a handle component and a base plate component to which the handle component is securely attached. These components may work as a “stand alone” device that is separate from the power tool component (as shown in FIGS. 1-6) or they may be incorporated into the housing of a designated power tool, such that the power tool and cutting or working components can adjust within the housing. In another aspect of the present invention, the device is a portable, power operated circular saw of the type described and shown in FIGS. 1 and 2, which saw embodies a new and improved adjustment mechanism of the cutting element angle relative to the base plate and handle. The present invention can be incorporated into any construction or arrangement of the various component parts and elements of existing circular saws, and in existing base plate or cutting element adjustment mechanisms.

In principle, the present invention serves to provide a constant “vertical” handle position, or a substantially perpendicular angle of the handle relative to the plane of the working surface. This constant handle position relative to the working surface plane provides a user the ability to continuously direct any stabilizing force applied to the device generally downward towards the working surface (also in conjunction with the forward movement of the device along the cutting line). By directing the stabilization force in this way, the device (and power tool) is less likely to slip or move off the forward cutting line. Thus, the device of the present invention provides a user with a more easily controllable and accurate cut line when cutting at an angle. The present invention is therefore convenient and effective for enabling operator adjustment, and is durable and efficient in use.

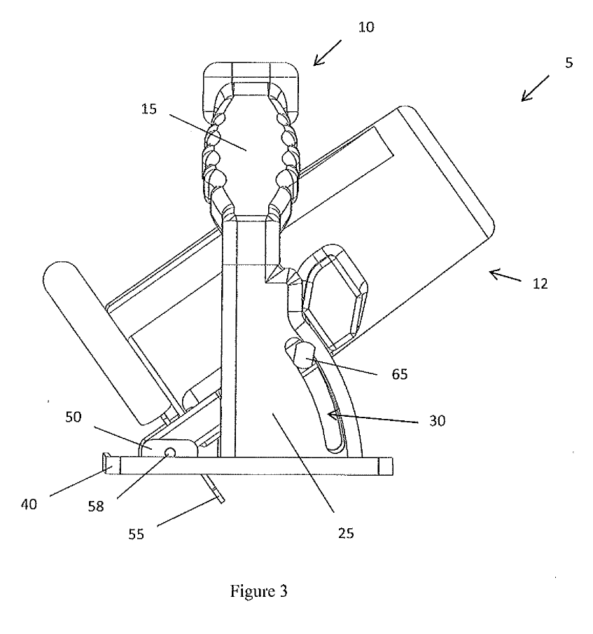

For example, FIGS. 1-3 show device 5, comprised generally of support platform 10 and power tool component 12. Support platform 10 includes handle 15, handle grip 20, handle arm 25, adjustment mechanism 30, base plate 40, working area 45 and tool engagement mechanism 50. Power tool component 12 may generally include a working element 55, attachment elements 58, motor 60 and adjustment elements 65. FIG. 1 illustrates the device in the vertical or default position, while FIGS. 2 and 3 illustrate the device with power tool component 12 positioned at an angle away from vertical.

Support platform 10 may be a stand-alone component that is separable from power tool component 12, or it may be incorporated at least in part with the housing of power tool component 12, so long as working element 55 of power tool component 12 can be adjusted to an angle with respect to base plate 40 that is different from the angle of handle 15 with respect to base plate 40. As contemplated herein, working element 55 is adjustable between an angular range of between about 1-90°, and any whole or partial increments therebetween. In certain embodiments, handle 15 and handle arms 25 can be positioned substantially above, or in line with, working element 55. In other embodiments, handle 15 and handle arms 25 can be positioned off-center, or out of line, from working element 55. The ultimate alignment of the handle and working element can be based on the type of power tool used, as would be understood by those skilled in the art.

Handle 15 may be a standard power tool handle suitable for grasping by one hand of a user of the power tool. For example, handle 15 may include a grip 20 molded to typical positioning of a user's fingers. In other embodiments, grip 20 may be a spongy or deformable material, or any other gripping feature or mechanism as would be understood by those skilled in the art. Handle arms 25 are generally support arms for fixing the handle to base plate 40. Handle arms 25 generally extend upward from base plate 40 at an angle substantially perpendicular from the base plate surface, such that a user has the ability to continuously direct any stabilizing force applied to the device generally downward towards the working surface (in conjunction with the forward movement of the device along the cutting line). By directing the stabilization force in this way, the power tool is less likely to slip or move off the forward cutting line. In alternative embodiments, handle arms 25 can have separate adjustment and/or engagement mechanisms around the attachment point of the handle arms to base plate 40 (not shown). However, such adjustment and engagement mechanisms should remain independent of adjustment mechanism 30.

Adjustment mechanism 30 allows for the adjustment of the angle of working element 55 with respect to base plate 40 and handle 15. In one embodiment, adjustment mechanism 30 may include a guided path for a component of power tool 12 (such as pin 65) to engage and travel along the path. Adjustment mechanism 30 can thither include designated angle settings 35, such that a user can position the power tool at a standard or highly desired angle. For example, angle settings 35 may include notches, detents, spring bias, clamping, lever or any mechanical locking mechanisms that are releasable, as would be understood by those skilled in the art. Temporary locking mechanisms may also include friction based locking (tightening) at any point along the guided path or other adjustment means incorporated into adjustment mechanism 30. Examples of such mechanisms are generally described in U.S. Pat. Nos. 4,221,051 and 4,516,324, the entire contents of which are incorporated by reference herein as if each being set forth herein in their entirety. It should also be appreciated that power tool 12 can be independently adjustable on one or both adjustment mechanisms 30 of each handle arm 25.

Tool engagement mechanism 50 may be any mechanical engagement means as would be understood by those skilled in the art. For example, power tool 12 may include a separate pin 58 for engaging a reciprocal bracket that is fixed to base plate 40, or alternatively to handle arm 25. Tool engagement mechanism 50 should allow for movement of power tool 12, so that the angle of working element 55 can be adjusted via adjustment mechanism 30. In another embodiment, tool engagement mechanism 50 may include a bracket that is pivotally mounted to support platform 10, by a pivot pin extending through a boss provided on support platform 10, thereby mounting power tool 12 for swinging movement back and forth between adjustment positions.

Base plate 40 may be a generally flat surface that rests on top of the working surface. Base plate 40 can be sized and shaped similar to any base plate for power tools as would be understood by those skilled in the art. Base plate 40 includes a working area 45, which allows working element 55 to access and engage the working surface therethrough. The space created by working area 45 can also be sized and shaped similar to any cutout within base plates for power tools as would be understood by those skilled in the art.

All components of support platform 10 can be constructed of standard materials used in power tools, including any combinations of rigid polymer, metal or metal alloys, such that the resulting device has the strength and stability of the desired power tool. Thus, the present invention can be constructed from any such materials as would be understood by those skilled in the art.

In one exemplary embodiment, power tool component 12 is a circular saw, where working element 55 is a circular cutting blade, attachment elements 58 are pins for fixedly or releasably attaching to a reciprocal hole within engagement mechanism 50, and adjustment elements 65 are pins for sliding along a guided path within adjustment mechanism 30. In operation, a user can adjust the position of power tool component 12 with respect to the support platform 10, such that the cutting blade is set to the desired angle with respect to base plate 40. Regardless of the angle that the cutting blade is set to, the angle of handle 15 and handle arms 25 with respect to base plate 40 remains the same, which is an angle that is substantially perpendicular.

It should be appreciated that any type of power tool can be used with the support platform of the present invention, and is not in any way limited to circular saws. The power tools may be portable, or integrated into a workbench or other framework. The motors may be electrical, or fueled by gasoline, gas/oil mix or other fuel base.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed;

1. A power tool, comprising:
a support platform component including a handle and a base plate;
a power tool component including a working element and means for engaging the support platform component that allows for rotational or pivotal movement of the power tool component relative to the support platform component; and
an adjustment mechanism that allows the working element of the power tool component to be adjusted to an angle relative to the base plate that is different from the angle of the handle relative to the base plate.

2. The power tool of claim 1, wherein the angle of the handle with respect to the base plate is substantially perpendicular.

3. The power tool of claim 1, wherein the angle of the working element relative to the base plate is between 1-90°.

4. The power tool of claim 1, wherein the adjustment mechanism is releasably locked into position.

5. The power tool of claim 4, wherein the locked position represented a predetermined angle of the working element relative to the base plate.

6. The power tool of claim 5, wherein a plurality of predetermined angle settings are designated on the adjustment mechanism.

7. The power tool of claim 1, wherein the support platform component in at least partially integrated into a housing of the power tool component.

8. The power tool of claim I, wherein the power tool is a circular saw.

9. The power tool of claim 8, wherein the working element is a cutting blade.

10. The power tool of claim 9, wherein the cutting blade makes a beveling or mitering cut angle while the handle is substantially perpendicular to the base plate.

11. A method of cutting a substantially planar surface at an angle with a power tool, comprising:
placing a power tool including a handle, cutting blade, motor and base plate on a surface to be cut, such that the base plate is substantially flush with the surface, the handle is substantially perpendicular with respect to the base plate, and the cutting blade is aligned along a cutting line on the surface;
adjusting the angle of a cutting blade, without substantially altering the position of the handle relative to the base plate; and
activating the cutting blade to cut the surface at an angle along the cutting line.

12. The method of claim 11, wherein the angle of the cutting blade relative to the base plate is between 1-90°.

13. The method of claim 11, wherein the adjusted cutting blade angle is releasably locked into position.

14. The method of claim 13, wherein the locked position represented a predetermined angle of the cutting blade relative to the base plate.

15. The method of claim 14, wherein a plurality of predetermined angle settings are designated on the circular saw.

16. The method of claim 11, wherein the handle is at least partially integrated into a housing of the circular saw.

17. The method of claim 11, wherein the cutting blade makes a beveling or mitering cut angle while the handle is substantially perpendicular to the base plate.

18. A support platform for a power tool, comprising:
a handle, handle arm and a base plate, wherein the handle arm or base plate includes a means for engaging a power tool component that allows for rotational or pivotal movement of the power tool component relative to the handle and base plate; and
an adjustment mechanism in the handle arm that allows a working element of the power tool component to be adjusted to an angle relative to the base plate that is different from the angle of the handle relative to the base plate.

19. The support platform of claim 18, wherein the angle of the handle arm with respect to the base plate is substantially perpendicular.

20. The support platform of claim 19, wherein the angle of the power tool working element relative to the base plate is between 1-90°.
